(19) United States
(12) Patent Application Publication
(10) Pub. No.: US 2009/0084982 A1
(43) Pub. Date: Apr. 2, 2009

(54) RADIATION SCINTILLATOR PLATE

(76) Inventors: Shinji Kudo, Tokyo (JP); Takehiko Shoji, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/093,552

(22) PCT Filed: Sep. 29, 2006
(86) PCT No.: PCT/JP2006/319444

§ 371 Date: May 13, 2008

(30) Foreign Application Priority Data
Nov. 18, 2005 (JP) 2005-334448

(51) Int. Cl. H05B 33/00

(52) U.S. Cl. 250/484.4

(57) ABSTRACT

A scintillator plate which exhibits enhanced emission efficiency upon exposure to radiation and an improved time efficiency in manufacture of the plate is disclosed, comprising on a substrate a phosphor layer containing an activator and having been subjected to a plasma treatment.

### TECHNICAL FIELD

The present invention relates to a radiation scintillator plate and in particular to a radiation scintillator plate which is provided with a layer of an activator-containing phosphor.

### TECHNICAL BACKGROUND

There have been broadly employed radiographic images such as X-ray images for diagnosis of the conditions of patients on the wards. Specifically, radiographic images using a intensifying-screen/film system have achieved enhancement of speed and image quality over its long history and are still used on the scene of medical treatment as an imaging system having high reliability and superior cost performance in combination. However, these image data are so-called analog image data, in which free image processing or instant image transfer cannot be realized.

Subsequently, there appeared computed radiography (also denoted simply as CR) as a radiographic image detection apparatus in a digital system. In the CR, digital radiographic images are directly obtained and can be displayed on an image display apparatus such as a cathode tube or liquid crystal panels, which renders it unnecessary to form images on photographic film and results in drastic improvement of convenience for diagnosis in hospitals or medical clinics.

The CR has been accepted mainly in medical sites, where X-ray images are obtained using a photostimulable phosphor plate. The photostimulable phosphor plate is one in which a radiation having been transmitted through an object is accumulated and excited in a time-series manner upon exposure to electromagnetic waves (exciting light) such as infrared light, whereby the accumulated radiation is emitted as stimulated emission at an intensity corresponding to the radiation dosage and which is constituted of a laminar photostimulable phosphor on a prescribed substrate.

However, this photostimulable phosphor plate, which is not sufficient in signal-to-noise ratio or sharpness and is also insufficient in spatial resolution, has not yet reached the image quality level of the conventional screen/film system.

Further, there appeared, as a digital X-ray imaging technology, an X-ray flat panel detector (FPD) using a thin film transistor (TFT), as set forth in, for example, an article “Amorphous Semiconductor Usher in Digital X-ray Imaging” described in Physics Today, November, 1997, page 24 and also in an article “Development of a High Resolution, Active Matrix, Flat-Panel Imager with Enhanced Fill Factor” described in SPIE, vol. 32, page 2 (1997).

The FPD has advantages such that it is superior to the CR in terms of downsizing of the apparatus being feasible and a moving image display. However, similarly to the CR, the FPT has not yet reached the image quality level of the screen/film system, so that desire for high image quality increased recently.

The FPD system employs a scintillator plate made of an emissive X-ray phosphor to convert radiation to visible light, in which electrical noise generated in TFT or in the circuit to drive the TFT is relatively high, so that even in imaging at a low dose, the SN ratio is lowered, making it difficult to ensure emission efficiency to maintain desired image quality level.

Generally, the emission efficiency of a scintillator plate depends of the phosphor layer thickness and X-ray absorbance of the phosphor. A thicker phosphor layer causes more scattering of emission within the phosphor layer, leading to deteriorated sharpness. Accordingly, necessary sharpness for desired image quality level necessarily determines the layer thickness.

Specifically, cesium iodide (CsI) used in the phosphor layer of a scintillator plate exhibits a relatively high conversion rate of from X-ray to visible light. Further, a columnar crystal structure of the phosphor can readily be formed through vapor deposition and its light guide effect inhibits scattering of emitted light within the crystal, enabling an increase of the phosphor layer thickness.

In the formation of a phosphor layer, since the use of CsI alone results in lowered emission efficiency, there may be used various additives. It is known that an additive content of not less than 0.01 molt, based on CsI enhances emission efficiency.

There was disclosed a technique for use as an X-ray phosphor in which a mixture of CsI and sodium iodide (NaI) at any mixing ratio was deposited on the substrate to form sodium-activated cesium iodide (CsI:Na), which was further subjected to annealing as a post-treatment to achieve enhanced visible-conversion efficiency.

Recently, there was also disclosed a technique for preparing an X-ray phosphor in which CsI is formed through deposition and activation material such as indium (In), thallium (Tl), lithium (Li), potassium (K), rubidium (Rb) or sodium (Na) was formed by spattering.

Patent Document 1: JP-B No. 54-35060 (hereinafter, JP-B refers to Japanese Patent Publication)

Patent Document 2: JP-A No. 2001-59899 (hereinafter, the term JP-A refers to Japanese Patent Application Publication)

### DISCLOSURE OF THE INVENTION

### Problem to be Solved

However, the emission efficiency of X-ray phosphors prepared according to the methods set forth in the patent documents 1 and 2 was still low. Gradual temperature rising is required to perform a heating treatment for enhancement of emission efficiency, rendering it difficult to perform production for a short time, and there were further desired improvements in emission efficiency and time efficiency.

In light of the foregoing, the present invention has come into being, and it is an object of the invention to provide a scintillator plate with enhanced time efficiency as well as enhanced emission efficiency upon exposure to radiation.

### Means for Solving the Problem

To solve the problems described above, a radiation scintillator plate of the invention as described in claim 1 is featured in that the scintillator plate comprises, on a substrate, an activator containing phosphor layer which was subjected to a plasma treatment.

The invention as described in claim 2 is the radiation scintillator plate as described in claim 1, wherein the phosphor layer is an aggregate of columnar crystals which are each comprised mainly of CsI and the activator.

The invention described in claim 3 is the radiation scintillator plate as described in claim 1, wherein the phosphor layer is an aggregate of columnar crystals comprised mainly of CsBr and the activator.

The invention described in claim 4 is the radiation scintillator plate as described in any one of claims 1 to 3, wherein the activator comprises at least one of indium (In), thallium (Tl), lithium (Li), potassium (K), rubidium (Rb), sodium (Na) and europium (Eu).

### EFFECT OF THE INVENTION

In the radiation scintillator plate of the invention described in claim 1, a phosphor layer containing an activator and having been subjected to a plasma treatment is provided on the substrate, whereby enhanced directionality of an emission upon exposure to radiation is achieved, leading to enhanced emission efficiency and such a treatment is feasible over a shorter time, leading to enhanced time efficiency.

In the invention as described in claim 2, the phosphor layer of the scintillator plate is an aggregate of columnar crystals comprised of CsI and an activator as main components. Thus, the phosphor layer of the radiation scintillator plate, which is CsI-based and formed by a process of gas phase deposition, needs not contain a binder in the formed phosphor layer, as compared to methods other than the gas phase deposition process, for example, a liquid phase process or a solid phase method, whereby an enhanced filling factor of the phosphor can be achieved, resulting in enhanced directionality of emission upon exposure to radiation and improved emission efficiency.

In the invention as described in claim 3, the phosphor layer of the scintillator plate is an aggregate of columnar crystals composed of CsBr and an activator as main components. Thus, the phosphor layer of the radiation scintillator plate, which is CsBr-based and formed by a process of gas phase deposition, needs not contain a binder in the formed phosphor layer, as compared to methods other than the gas phase deposition process, for example, a liquid phase process or a solid phase method, whereby an enhanced filling factor of the phosphor can be achieved, resulting in enhanced directionality of emission upon exposure to radiation and improved emission efficiency.

In the invention as described in claim 4, the activator comprises, similarly to the foregoing claims 1 to 3, at least one of indium (In), thallium (Tl), lithium (Li), potassium (K), rubidium (Rb), sodium (Na) and europium (Eu), which, similarly to the foregoing claims 1 to 3, results in enhanced directionality of emission upon exposure to radiation and improved emission efficiency.

### BRIEF DESCRIPTION OF THE DRAWINGS

FIG. 1 illustrates a sectional view of a scintillator plate of the invention.

FIG. 2 illustrates a deposition apparatus usable in the invention.

FIG. 3 illustrates the manner in which a phosphor layer is formed on the substrate.

### DESCRIPTION OF DESIGNATION

1: Substrate
2: Phosphor layer
10: Radiation scintillator plate
20: Deposition apparatus
21: Vacuum pump
22: Vacuum vessel
23: Resistance-heating crucible
24: Rotation mechanism
25: Substrate holder

### PREFERRED EMBODIMENTS OF THE INVENTION

First, the preferred embodiments of the invention will be described with reference to the drawings but the invention is by no means limited to these.

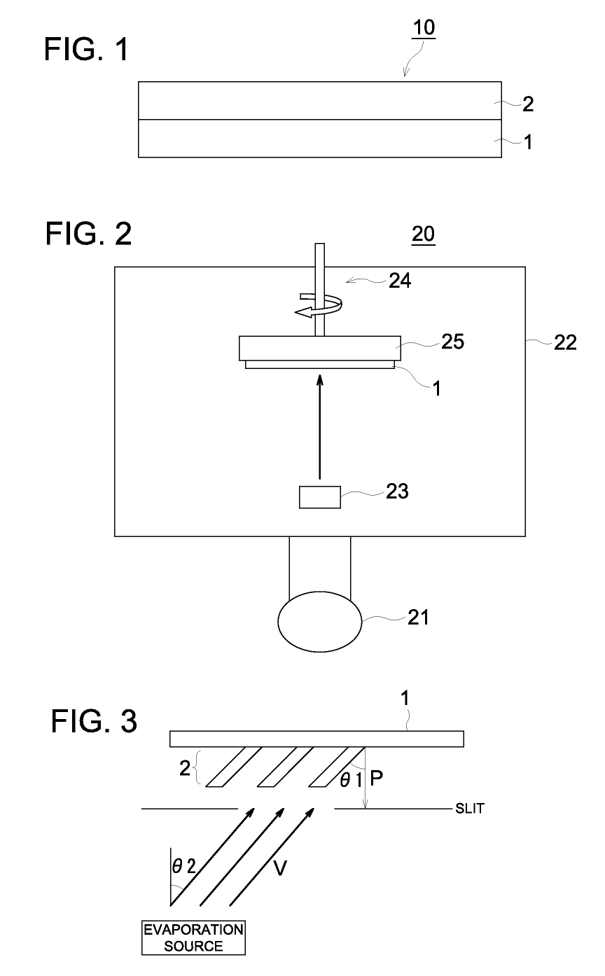

As shown in FIG. 1, a scintillator plate (10) used for radiation, of the invention is provided with a phosphor layer (2) on a substrate 1. When the phosphor layer (2) is exposed to radiation, the phosphor layer (2) emits an electromagnetic wave at the wavelength of 300 to 800 nm, that is, electromagnetic waves of from ultraviolet light to infrared light, centered in the visible light, upon absorption of incident radiation energy.

The substrate (1), which is transparent to radiation such as X-rays, employs a resin or glass substrate or a metal plate, but a 1 mm thick aluminum plate or resin sheet such as carbon-fiber-reinforced resin sheet are preferably used in terms of enhanced durability and lightweight.

The phosphor layer (2) is formed of Cs-based crystals, of which CsI is preferred. The phosphor layer (2) contains an activator and when it is CsI-based, any activator is usable in the invention, which can be appropriately chosen with fitting required characteristics such as emission wavelength and moisture resistance.

Specific examples thereof include compounds of indium (In), thallium (Tl), lithium (Li), potassium (K), rubidium (Rb), sodium (Na), europium (Eu), copper (Cu), Cerium (Ce), zinc (Zn), titanium (Ti), gadolinium (Gd) and terbium (Tb). Of these, at least one can be chosen but activators are not limited to these.

CsI as a based phosphor may be replaced by CsBr or CsCl. The phosphor layer 2 may be composed of a crystal based on a mixed crystal formed of at least two phosphors of CsI, CsBr and CsCl at an arbitrary mixing ratio.

There will be described a method of forming the phosphor layer (2) on the substrate 1.

The phosphor layer (2) is formed by the method of vapor deposition, which is performed in the following manner.

The substrate (1) is set inside a commonly known deposition apparatus and then, the inside of the apparatus is evacuated to form vacuum at 1.333 Pa to 1.33×10³ Pa, concurrently with introducing inert gas such as nitrogen from the entrance. Subsequently, at least one of raw materials of a phosphor is vaporized with heating by a method such as a resistance heating method or an electron beam method and deposited on the substrate (1) to form a phosphor layer (2) having a prescribed thickness. Thereby, the phosphor layer (2) containing no binder is formed. This deposition process may be repeated plural times to form the phosphor layer (2).

The substrate (1) may optionally be heated or cooled during deposition.

With reference to FIG. 2, there will be described a deposition apparatus (20), as one example of deposition apparatuses used when performing vapor deposition.

The deposition apparatus is provided with a vacuum pump (21) and a vacuum vessel (22) which is internally evacuated by operation of the vacuum pump (21). A resistance heating crucible (23) as a deposition source is provided in the inside of the vacuum vessel. On the upper side of the resistance heating crucible (23), a substrate (1) is provided via a substrate holder (25) which is pivotable through a rotation mechanism (24). A slit to control a vapor stream of a phosphor vaporized from the resistance heating crucible (23) is provided between the resistance heating crucible 23 and the substrate (1). When operating the deposition apparatus (20), the substrate (1) is used while placed on the substrate holder (25).

A sputtering method is conducted similarly to the vapor deposition. Thus, after the substrate (I) is set within a commonly known sputtering apparatus, the inside of the apparatus is evacuated to form a vacuum and then, an inert gas for sputtering, such as Ar or Ne is introduced into the apparatus to form a gas pressure of approximately 1.33 Pa to 1.33×10⁻³ Pa. Subsequently, sputtering is performed with targeting the phosphor described above to deposit the phosphor at a desired thickness on the substrate (1). Similarly to the vapor deposition method, this sputtering step may be divided into plural times to form the phosphor layer (2) or using each of them, the target may be sputtered simultaneously or successively to form the phosphor layer (2). In the sputtering method, plural raw phosphor materials as a target may be sputtered simultaneously or successively to form the objective phosphor layer (2) on the substrate (1). Optionally, a gas such as O₂ or H₂ may be introduced to perform a reactive-sputtering. In the sputtering method, the substrate 1 may be cooled or heated during sputtering. The phosphor layer (2) may be heated after completion of sputtering.

In a CVD method, an organic metal compound containing a phosphor or its raw material is decomposed by an energy such as heat or a high-frequency electric power to form the phosphor layer (2) containing no binder on the substrate 1.

Either method is feasible to allow elongated columnar crystals to grow at an inclination to the normal line in a gas phase to form the phosphor layer 2.

These columnar crystals can be obtained by the method described in JP-A No. 2-58000, in which a vapor of a phosphor or its raw material is supplied onto the substrate 1 to perform gas-phase growth (deposition) such as vapor deposition.

FIG. 3 illustrates an example of a gas-phase deposition (vapor deposition) apparatus and the mode of forming a phosphor layer on a substrate 1 through vapor deposition by using such a gas-phase deposition apparatus. A vapor stream “V” vaporized from the vaporization source is introduced at an entrance angle θ2 and columnar crystals are formed at an angle of θ1 to the direction (P) normal to the surface of the substrate (1) (hereinafter, also denoted as the substrate surface) with depending on the entrance angle θ2. The angle of formed columnar crystals depends on the phosphor material and in the case of a CsI-based phosphor, for example, when a vapor stream of a phosphor enters at an angle of 0-5 degrees from the line normal to the substrate 1 (that is θ2 of 0-5 degrees) during vapor deposition, there can be obtained columnar crystals which are almost vertical to the substrate surface (that is θ1 being nearly zero degree).

A phosphor layer (2) thus formed on the substrate (2), which does not contain any binder, is superior in directionality resulting in enhanced directionality of the exciting light and emitting light and having a thickness greater than radiation scintillator plates having a dispersion-type phosphor layer in which a phosphor is dispersed in a binder. Yet further, reduced scattering of exciting light within the phosphor layer (2) results in enhanced image sharpness.

Spaces between columnar crystals may be filled with filler such as a binder, reinforcing the phosphor layer (2). It may be filled with a highly light-absorptive material or a highly light-reflective material, whereby lateral light diffusion of exciting light incident to the phosphor layer (2) can be completely inhibited in addition to the reinforcement effect as described above.

The highly light-reflective material refers to one exhibiting high reflectance of exciting light (500-900 nm, specifically 600-800 nm) and there are usable, for example, aluminum, magnesium, silver, indium and other metals; white pigments and coloring materials in the range of green through red.

White pigments can reflect emitted light. White pigments include, for example, TiO₂ (rutile type, anatase type), MgO, PbCO₃, Pb(OH)₂BaSO₄, Al₂O₃, M(II)FX [in which M(II) is at least one of Ba, Sr and Ca, and X is at least one of Cl and Br], CaCO₃, ZnO, Sb₂O₃, SiO₂.ZrO₂, lithopone (BaSO₄.ZnS)/magnesium silicate, basic lead silisulfate, basic lead phosphate, and aluminum sulfate. These white pigments, which exhibit strong covering power and a high refractive index, easily scatter emitting light through reflection or refraction, resulting in markedly enhanced sensitivity of the radiation scintillator plate 10.

Examples of a highly light-absorptive material include carbon, chromium oxide, nickel oxide, iron oxide, and blue coloring materials. Of these, carbon absorbs emitting light.

Coloring materials may be any one of organic and inorganic coloring materials. Examples of organic coloring materials include zabon Fast Blue 3G (produced by Hoechst), Estrol Bril Blue N-3RL (produced by Sumitomo Kagaku Co., Ltd.) D & C Blue No. 1 (produced by national Aniline Corp.), Spirit Blue (produced by HODOGAYA KAGAKU Co., Ltd.), Oil Blue No. 603 (Produced by Orient Co.), Kiton Blue A (produced by Ciba Geigy Co.), Eisen Catilon Blue GLH (produced by HODOGAYA KAGAKU Co., Ltd.), Lake Blue AFH (produced by KYOWA SANGYO Co., Ltd.), Primocyanine 6GX (produced by Inahata Sangyo Co., Ltd.), Brilacid Green 6BH (produced by HODOGAYA KAGAKU Co., Ltd.), and Lyonoyl Blue SL (Produced by Toyo Ink Co., Ltd.) There are also cited organic metal complex coloring materials such as Color Index Nos. 24411, 23160, 74180, 74200, 22800, 23154, 23155, 24401, 14830, 15050, 15760, 15707, 17941, 74220, 13425, 13361, 13420, 11836, 74140, 74380, 74350, and 74460. Examples of an inorganic colorant include cobalt blue, celurean blue, chromium oxide and TiO₂—ZnO—Co—NiO type pigments.

After thus forming the phosphor layer (2) on the substrate 1, the phosphor layer (2) is subjected to a plasma treatment. In the following, there will be described a plasma treatment.

The plasma treatment relating to the invention refers to a treatment for producing plasma, that is, a treatment in which gas molecules are excited and dissociated into ions and electrons to generate an ionization state, forming an assemblage of positive-charged ions and negative-charged electrons.

Plasma, which has high energy and exhibits high reactivity, easily reacts with the surface of substances, so that such characteristics are utilized to meet various purposes. For instance, treatments such as etching, cleaning and the like can be easily and rapidly conducted in a dry state.

Plasma can be generated by commonly known plasma generating apparatuses, for example, by using a reactive dry etching apparatus.

When performing a plasma treatment by using a reactive dry etching apparatus, it is preferred that oxygen, nitrogen, argon gas or a mixture of these gases is introduced into the apparatus and glow discharge is caused at a gas flow rate of 20 to 200 SCCM and an evacuation degree of 1 to 100 Pa, and preferably at a treatment time of 1 to 30 min.

In the invention, as a result of extensive study, it was found that although detailed action mechanism was not clarified, subjecting the phosphor layer (2) of the radiation scintillator plate (10) to a plasma treatment smoothened the surface of the phosphor layer (2), resulting in enhanced directionality of emitted light upon exposure to radiation, whereby enhanced emission efficiency was achieved. It was further found that this plasma treatment could be performed for a short period of time, enabling manufacture of plates within a short time, as compared to conventional methods for enhancing emission efficiency.

Next, there will be described action of the radiation scintillator plate (10). When radiation enters the radiation scintillator plate (10) from the phosphor layer (2) side toward the substrate (1) side, any radiation which has entered the phosphor layer (2) is absorbed by phosphor particles of the phosphor layer (2), emitting electromagnetic waves in accordance with its intensity.

It is presumed that when subjected to a plasma treatment, the surface of the phosphor layer (2) becomes smooth by its etching action and adequate spacing is secured between columnar crystals with enhanced light guide effect. Directionality of instantaneous emission in the phosphor layer and emitting efficiency of electromagnetic waves are enhanced, resulting in greatly improved radiation sensitivity of the radiation scintillator plate (10). There are also expected improvements of graininess and sharpness of images.

The radiation scintillator plate (10) relating to the invention can achieve enhanced emission efficiency of the phosphor layer (2) as well as improved emission electromagnetic waves and improved emission efficiency of electromagnetic waves and also attains enhanced time efficiency for manufacture.

### EXAMPLES

The present invention will be further described with reference to examples but the embodiments of the invention are by no means limited to these.

Sample 1 through Sample 5 were each prepared in the following manner.

### (1) Preparation of Sample

### (1.1) Preparation of Sample 1:

To cesium iodide (CsI) was added thallium iodide (TlI) as an activator at a ratio of 0.3 mol %, after which the CsI and TlI were mixed homogeneously with grinding the mixture in a mortar. Then, applying a carbon fiber reinforced resin sheet as a substrate and a vapor deposition apparatus similar to the vapor deposition apparatus (3) of FIG. 3, a phosphor layer was formed on the substrate.

Specifically, the foregoing powdered mixture as a deposition material was placed into a boat and the substrate was set onto a holder. The distance between the boat and the holder was adjusted to 400 mm (preliminary step). Subsequently, a vacuum pump was operated and the interior of a vacuum vessel was evacuated to form a vacuum atmosphere at 1.0×10⁻⁴ Pa (vacuum atmosphere formation step). Thereafter, electric current was applied from an electrode to the boat and the mixture filled in the boat was heated at 350° C. for 2 hrs. (heating step).

Subsequently, the interior of the vacuum vessel was again evacuated and argon gas was introduced thereto, and the interior of the vacuum vessel was adjusted to a vacuum degree of 0.1 Pa. Then, a motor of a rotation mechanism and a heater of the holder were operated, and the substrate was heated at 150° C. with rotating at a speed of 10 rpm. While maintaining this state, a large amount of electric current was passed from the electrode to the boat and the foregoing mixture filled in the boat was heated at 700° C. and then evaporated to form a phosphor layer on the substrate. When the thickness of the phosphor layer reached 500 μm, deposition onto the substrate was completed (deposition step) and allowed to stand until the interior of the vacuum vessel reached room temperature (cooling step).

Thereafter, the sample obtained in the cooling step was subjected to a plasma treatment. When performing the plasma treatment, there was used a reactive dry-etching apparatus DEM-451 (produced by ANELVA Co.).

Specifically, in a plasma treatment apparatus installed with paired parallel electrodes (electrode area: 300 mmφ), a sample was set on one of the electrodes and the distance between electrodes was adjusted to 45 mm. Subsequently, oxygen gas was introduced into the plasma treatment apparatus at a flow rate of 50 SCCM and the interior of the apparatus was adjusted to a vacuum degree of 10 Pa. In such state, a high-frequency at 200 W and 13.56 MHz was applied thereto to perform glow discharge for 10 min (0.17 hr.). The thus obtained product was designated as Sample 1.

### (1.2) Preparation of Sample 2:

Sample 2 was prepared similarly to Sample 1 of the foregoing (1.1), provided that the plasma treatment was not conducted, that is, the product after completion of the cooling step was designated as Sample 2.

### (1.3) Preparation of Sample 3:

Sample 2 was prepared similarly to Sample 1 of the foregoing (1.1), provided that the plasma treatment was replaced by the following heating treatment.

The heating treatment was divided into a pre-step, a mid-step and a post-step. The heating treatment was performed after completion of the cooling step. There was a concern that rapid heating would cause the phosphor layer to crack or peel due to the difference in thermal expansion coefficients between the substrate and the phosphor layer. Accordingly, heating was conducted with gradually raising the temperature in the pre-step, heating at a constant temperature in the mid-step and gradually lowering the temperature in the post-step.

There was used Labo Oven LP-101 (produced by ESPEC co.) as a thermostatic oven.

Concretely, the product which had completed the cooling step was moved to the inside of a thermostatic oven maintained at 20° C. and the temperature was gradually raised to 150° C. over 1.5 hr. (pre-step).

Subsequently, the temperature (150° C.) within thermostatic oven was maintained over 1 hr. (mid-step).

Thereafter, the temperature was gradually lowered so that the temperature within the thermostatic oven maintained at 150° C. reached 20° C. over 1.5 hr. (post-step), and the obtained product was designated as Sample 3.

### (1.4) Preparation of Sample 4:

Sample 4 was prepared similarly to the foregoing preparation of Sample 3 (1+3), provided that the periods for the pre-step and the post-step were each changed to 0.5 hr.

### (1.5) Preparation of Sample 5:

Sample 5 was prepared similarly to the foregoing preparation of Sample 3 (1.3), provided that the periods for the pre-step and the post-step were each changed to 0.2 hr.

### (2) Measurement of Luminance of Samples

The back side (not having a phosphor layer) of the respective samples was exposed to X-rays at a tube voltage of 80 kVp, whereby instantaneously emitted light was taken out through an optical fiber and its emission amount was measured by a photodiode, produced by Hamamatsu Photonics Co. (S2281) and the measured value was defined as emission luminance (sensitivity) The measurement results of Samples 1 through 5 are shown in Table 1. In Table 1, emission luminance of each of Samples 1 to 5 is represented by a relative value, based on the emission luminance of Sample 2 being 1.0.

TABLE 1

| | | | | | Total | | |
|---|---|---|---|---|---|---|---|
| Sample | Treatment | Treatment Condition | | | Treatment | Emission | |
| No. | Means | Pre-Step | Mid-Step | Post-Step | Time | Luminance | Remark |
| 1 | plasma | 0.17 hr | | | 0.17 hr | 1.60 | Inv. |
| 2 | — | — | | | — | 1.00 | Comp. |
| 3 | Heating | 20° C.→150° C. 1.5 hr | 150° C. 1 hr | 150° C.→20° C. 1.5 hr | 4 hr | 1.40 | Comp. |
| 4 | Heating | 20° C.→150° C. 0.5 hr | 150° C. 1 hr | 150° C.→20° C. 0.5 hr | 2 hr | 1.23 | Comp. |
| 5 | heating | 20° C.→150° C. 0.2 hr | 150° C. 1 hr | 150° C.→20° C. 0.2 hr | 1.4 hr | 1.15 | Comp. |

From electron-microscopic analysis of Samples 1-5, it was confirmed that the phosphor layer surface of Sample 1 was smoother than Sample 2-5 though it is not indicated in the results.

### (3) Summary

As shown in Table 1, it was proved that the emission luminance of Samples 3-5 are respectively 1.40. 1.23 and 1.15, based on Sample 2; samples which were subjected to a heating treatment after cooling resulted in enhanced emission luminance, as compared to samples which were not subjected to the heating treatment.

On the other hand, it was proved that Sample 1 of the invention, which was subjected to a plasma treatment after cooling, exhibited an emission luminance of 1.60 and the sample which was subjected to a plasma treatment after cooling resulted in markedly enhanced emission luminance, as compared to samples which were not subjected to the plasma treatment.

The total treatment duration necessary to achieve emission luminance at the levels of Samples 2-5, which were subjected to a heating treatment was in the range of 1.4 to 4 hr., while on the contrary, the total treatment time necessary to achieve emission luminance at the level of Sample 1 which was subjected to a plasma treatment was 0.17 hr., from which, to obtain a scintillator plate at a level comparable to one which was subjected to the heating treatment, markedly enhanced time efficiency was achieved.

Accordingly, it was proved that a plasma treatment was practically beneficial for a scintillator plate which formed a phosphor layer on the substrate through vapor deposition.

1-4. (canceled)

5. A radiation scintillator plate, wherein the scintillator plate comprises on a substrate a phosphor layer containing an activator and having been subjected to a plasma treatment.

6. The radiation scintillator plate as claimed in claim 5, wherein the phosphor layer is an aggregate of columnar crystals which comprise CsI and the activator.

7. The radiation scintillator plate as claimed in claim 5, wherein the phosphor layer is an aggregate of columnar crystals which comprise CsBr and the activator.

8. The radiation scintillator plate as claimed in claim 5, wherein the activator comprises at least one selected from the group consisting of indium (In), thallium (TI), lithium (Li), potassium (K), rubidium (Rb), sodium (Na) and europium (Eu).

9. A method of preparing a radiation scintillator plate, the method comprising:
depositing a phosphor on a substrate to form a phosphor layer and subjecting the phosphor layer to a plasma treatment,
wherein the phosphor layer contains an activator.

10. The method as claimed in claim 9, wherein the phosphor layer is an aggregate of columnar crystals which comprise CsI and the activator.

11. The method as claimed in claim 9, wherein the phosphor layer is an aggregate of columnar crystals which comprise CsBr and the activator.

12. The method as claimed in claim 9, wherein the activator comprises at least one selected from the group consisting of indium (In), thallium (TI), lithium (Li), potassium (K), rubidium (Rb), sodium (Na) and europium (Eu).
